(19) United States
(12) Patent Application Publication
(10) Pub. No.: US 2014/0375717 A1
(43) Pub. Date: Dec. 25, 2014

(54) INK JET PRINTING APPARATUS AND INK JET PRINTING METHOD

(71) Applicant: CANON KABUSHIKI KAISHA, Tokyo (JP)

(72) Inventors: Takeshi Yazawa, Yokohama-shi (JP); Kei Yoshizawa, Yokohama-shi (JP)

(21) Appl. No.: 14/304,059

(22) Filed: Jun. 13, 2014

(30) Foreign Application Priority Data
Jun. 21, 2013 (JP) 2013-130992

(51) Int. Cl. B41J 2/21

(52) U.S. Cl. CPC B41J 2/2114
USPC 347/12

(57) ABSTRACT

Printing with color material inks is performed in an area (i.e., a unit area) having a width of 128 pixels by scanning four times. In contrast, in a mask pattern for a colorless ink, there are no ON dots at portions corresponding to the first pass to the fourth pass whereas there are ON dots in mask areas corresponding to a fifth pass and a seventh pass. Specifically, printing with respect to the unit area is completed by scannings eight times consisting of alternately forward scan and backward scan. In this case, the printing with the colorless ink is performed in the fifth pass and the seventh pass, that is, scanning in the same direction. In this manner, the dot printing misregistration with the colorless ink is reduced, thus suppressing the fluctuation of coverage with respect to the color material inks.

### BACKGROUND OF THE INVENTION

1. Field of the Invention

The present invention relates to an ink jet printing apparatus and an ink jet printing method and, more particularly, to an ink jet printing apparatus for performing printing with a colorless ink not containing a color material in addition to a color material ink, and a method therefor.

2. Description of the Related Art

It has been known that the use of a colorless ink not containing a color material in addition to a normal ink containing a color material such as a dye or a pigment adjusts the smoothness of an image printed with a color material ink, thus improving the quality of the image. Japanese Patent Laid-open No. 2011-218564 discloses that, in the case of, in particular, the use of a pigment ink, an image is printed with a color material ink, before applying a colorless ink for reducing glossiness of the image to thus reduce a reflected light from a surface of the image of dark gradation, so that a color having a lower lightness is reproduced, thus achieving printing in a wide color reproduction range.

However, as disclosed in Japanese Patent Laid-open No. 2011-218564, in printing in which the colorless ink is applied to the image formed with the color material ink to cover the image of the color material ink, the landing position accuracy of the colorless ink has an effect on a coverage to be fluctuated. As a consequence, gloss unevenness conspicuously appears in the dark gradation.

Specifically, printing is performed with a color material ink in a sheet coverage of 100% or more in order to achieve a high color reproducibility in the dark gradation. Therefore, a change in sheet coverage caused by landing position variation of the color material ink is small, and so-called density unevenness hardly occurs. In contrast, in a case where an image formed with a color material ink is covered with a colorless ink, the colorless ink is used in print amount smaller than that of the color material ink such that the coverage of the colorless ink covering the color material ink becomes about 90% or less, for example. In view of this, the occurrence of landing position variation of the colorless ink is easily to cause the fluctuation of the coverage. The proportion of the fluctuation of the amount of reflection light caused by a change in coverage of the colorless ink becomes large in the dark gradation in which the amount of reflection light is small. When the coverage of the colorless ink is changed due to the landing position variation, a difference in dark gradation between a region where the landing position variation occurs and a region where no landing position variation occurs is visually recognized as gloss unevenness, thus inducing degradation of a quality of an image.

As described above, in a case where the image formed with the color material ink is covered with the colorless ink, followed by printing, there arises a problem that a desired quality of an image cannot be achieved with the colorless ink if its coverage is fluctuated from a desired value.

A technique for giving, to dot arrangement, noise for reducing the spacial frequency of the dot arrangement may be used as a method for suppressing the fluctuation of the sheet coverage caused by the landing position variation of the colorless ink. FIG. 11 is a graph illustrating the measurement results of a relationship between landing position variation and glossiness at large, middle, and small noises given to the arrangement of dots formed with a colorless ink. In this example, image data is an image of black. As for such image, it is desirable that the measurement result of the glossiness should be low, and further, that a change in glossiness with respect to landing position variation should be small. As illustrated in FIG. 11, although the peak of the glossiness is favorably low at the small noise, the fluctuation of the glossiness is large at the time of occurrence of the landing position variation, and therefore, the gloss unevenness is liable to be visually recognized. As the noise is increased to the middle level, and further, to the high level, the fluctuation of the glossiness gradually becomes smaller at the time of occurrence of the landing position variation. Although in this point, the result looks preferable, the glossiness becomes high, and further, the black image lacks sharpness. In this manner, the method for giving the noise to the dot arrangement can suppress the fluctuation of the glossiness with respect to the change in landing position variation, that is, the change in coverage. However, a desirable quality of an image may not be achieved accordingly.

### SUMMARY OF THE INVENTION

The present invention has been accomplished to solve the above-described problems. Therefore, an object of the present invention is to provide an ink jet printing apparatus and a printing method that are capable of suppressing gloss unevenness caused by landing position variation of a colorless ink, and further, achieving a desired quality of an image.

In a first aspect of the present invention, there is provided an ink jet printing apparatus, comprising: a print head including arrays of nozzles for ejecting a color material ink containing a color material and nozzles for ejecting a colorless ink not containing a color material; and a print control unit configured to cause a print head to scan a print medium for ejecting a color material ink onto the print medium and then ejecting a colorless ink to form dots with the colorless ink in such a manner as to cover dots formed with the color material ink, wherein the ink jet printing apparatus is configured such that a shift of a dot formation position of the colorless ink is smaller than that of a dot formation position of the color material ink, the shift being caused by the scanning by the print head.

In a second aspect of the present invention, there is provided an ink jet printing method for causing a print head to scan a print medium and then performs printing, the print head having arrays of nozzles for ejecting a color material ink containing a color material and nozzles for ejecting a colorless ink not containing a color material, the method comprising: a print controlling step of causing a print head to scan a print medium for ejecting a color material ink onto the print medium and then ejecting a colorless ink to form dots with the colorless ink in such a manner as to cover dots formed with the color material ink, wherein a shift of a dot formation position of the colorless ink is smaller than that of a dot formation position of the color material ink, the shift being caused by the scanning by the print head.

In a third aspect of the present invention, there is provided a printing apparatus comprising: a print head for ejecting color ink and clear ink for coating the color ink to a print medium; first and second rollers that are provided on an upstream side and a downstream side of printing position on the print medium by the print head in a conveying direction of the print medium, respectively, so as to support and convey the print medium; and a print control unit configured to cause the print head and the print medium to move forward and backward relatively to each other in directions crossing the conveying direction and cause the print head to eject the color ink and the clear ink in a plurality of the relative movements of the print head and the print medium for performing printing to a unit area on the print medium, wherein the print control unit causes the print head to eject the clear ink in only the plurality of the relative movement of either of the forward and backward movements, at least in a case where the print medium is supported only by either one of the first and the second rollers.

In a fourth aspect of the present invention, there is provided a printing apparatus comprising: a print head for ejecting color ink and clear ink for coating the color ink to a print medium; a conveying unit configured to convey the print medium in a conveying direction; and a print control unit configured to cause the print head and the print medium to move forward and backward relatively to each other in directions crossing the conveying direction and cause the print head to eject the color ink and the clear ink in a plurality of the relative movements of the print head and the print medium for performing printing to a unit area on the print medium, wherein the print control unit causes the print head to eject the clear ink in only the plurality of the relative movement of either of the forward and backward movements, at least in a case where printing is performed to either one of end portions of the print medium in the conveying direction.

With the above-described configuration, it is possible to suppress gloss unevenness caused by landing position variation of a colorless ink, and further, achieve a desired quality of an image.

Further features of the present invention will become apparent from the following description of exemplary embodiments (with reference to the attached drawings).

### BRIEF DESCRIPTION OF THE DRAWINGS

FIG. 1 is a perspective view showing the configuration of main parts in an ink jet printing apparatus according to an embodiment of the present invention;

FIG. 2 is a diagram schematically illustrating the arrangement of nozzle arrays (nozzle groups) for ejecting inks of twelve colors in a print head shown in FIG. 1;

FIGS. 3A and 3B are diagrams explanatory of effects in a case where a colorless ink is ejected after a color material ink is ejected;

FIG. 4 is a block diagram illustrating a control structure in the ink jet printing apparatus according to the embodiment of the present invention;

FIG. 5 is a block diagram illustrating a structure of image processing in the ink jet printing apparatus and a host apparatus according to the embodiment of the present invention;

FIG. 6 is a diagram schematically illustrating a dot pattern to be used in the embodiment of the present invention;

FIG. 7A is a diagram illustrating an example of a 4-pass mask pattern, with which an image is formed by scanning four times;

FIG. 7B is a diagram schematically illustrating multi-pass printing with the mask pattern illustrated in FIG. 7A;

FIGS. 8A to 8C are diagrams schematically illustrating mask patterns for a color material ink and a colorless ink according to the embodiment of the present invention and a comparative example;

FIGS. 9A to 9C are diagrams explanatory of the multi-pass printing with the mask pattern for the color material ink and the mask pattern for the colorless ink in the embodiment of the present invention and the comparative example;

FIGS. 10A to 10I are diagrams explanatory of changes in coverage of, in particular, the colorless ink in a case where printing is performed in both of forward and backward scanning directions with the color material ink and the colorless ink;

FIG. 11 is a graph illustrating measurement results of a relationship between landing position variation amount and glossiness in a dot arrangement when noises given to the dot arrangement of the colorless ink are varied on large, middle, and small levels;

FIGS. 12A to 12E are cross-sectional views schematically showing a printing part in the printing apparatus of the present embodiment;

FIGS. 13A to 13C are views schematically showing the relationship between the landing position of an ink droplet ejected from a print head 1 during scanning in a forward direction and the landing position of an ink droplet ejected during scanning in a backward direction;

FIGS. 14A and 14B are views schematically showing landing positions in a case where the ink is ideally landed by two nozzle arrays;

FIGS. 15A and 15B are views schematically showing landing positions in a case where ink droplets are ejected at different angles from each of the two nozzle arrays; and

FIGS. 16A and 16B are diagrams illustrating the arrangements of nozzle arrays in a print head in second and third embodiments, respectively.

### DESCRIPTION OF THE EMBODIMENTS

Embodiments of the present invention will be described below with reference to the drawings.

### First Embodiment

### Configuration of Apparatus

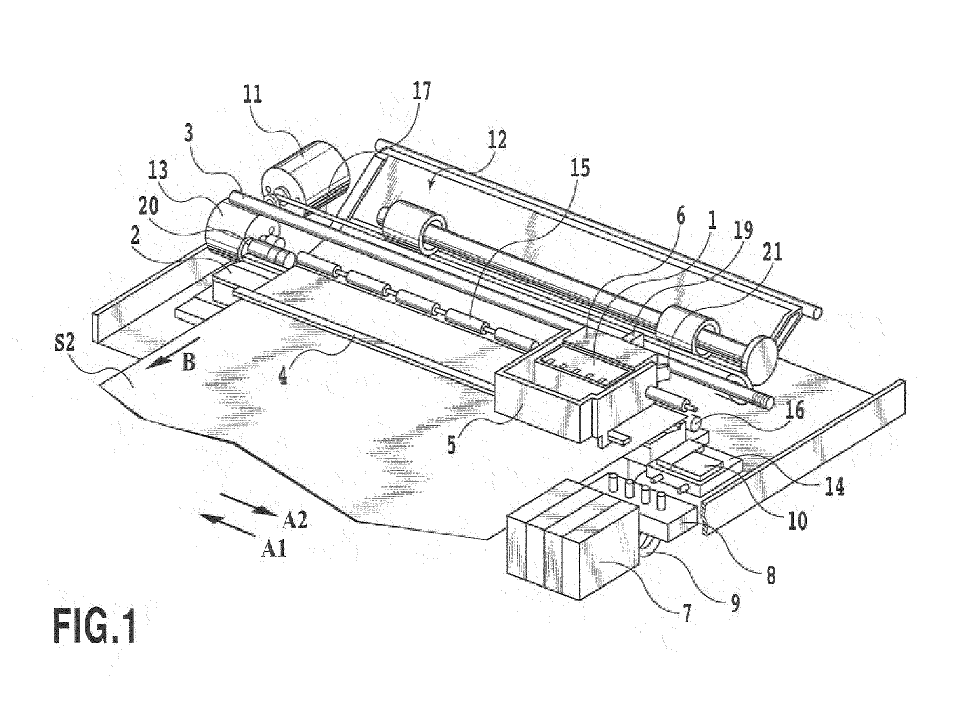

FIG. 1 is a perspective view showing the configuration of main parts in an ink jet printing apparatus according to an embodiment of the present invention. In FIG. 1, a print medium S2 such as a print sheet is fed from a sheet feed tray 12 to a printing part; the print medium is intermittently conveyed in a direction indicated by an arrow B while an image is printed on the print medium; and then, the print medium is discharged to a sheet discharge tray upon completion of printing. In the printing part, a print head 1 mounted on a carriage 5 is moved forward and reversely under the guidance of a guide rail 4 in directions indicated by arrows A1 and A2. During this movement, an ink is ejected from nozzles of the print head, and thus, an image is printed on the print medium S2. The print head 1 includes a plurality of nozzle groups corresponding to inks of different colors. Specifically, the print head 1 is provided with nozzle groups for ejecting inks of twelve colors: color material inks such as cyan (C), magenta (M), yellow (Y), light cyan (LC), light magenta (LM), mat black (MBk), photo black (PBk), dark gray (DGy), gray (Gy), light gray (LGy), and red (R) and a transparent colorless ink (CO; clear ink) not containing a color material. These color inks are reserved in corresponding ink tanks, not shown, and are supplied to the print head 1.

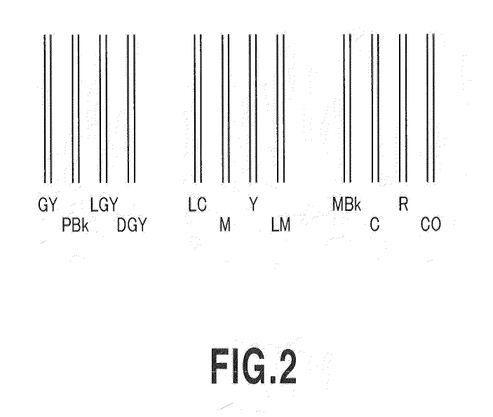

FIG. 2 is a diagram schematically illustrating the arrangement of nozzle arrays (nozzle groups) for ejecting the inks of the twelve colors in the print head 1. In the present embodiment, each of the nozzle groups for the colors includes two nozzle arrays, each of which has 512 nozzles at an interval of 600 dpi. The two nozzle arrays for the same color are arrayed to be shifted from each other with an interval of 1200 dpi in a nozzle array direction, and thus correspond to a nozzle array for one color having 1024 nozzles at an interval of 1200 dpi. Here, each of the nozzles ejects the ink in substantially the same ejection amount, that is, 3 pl.

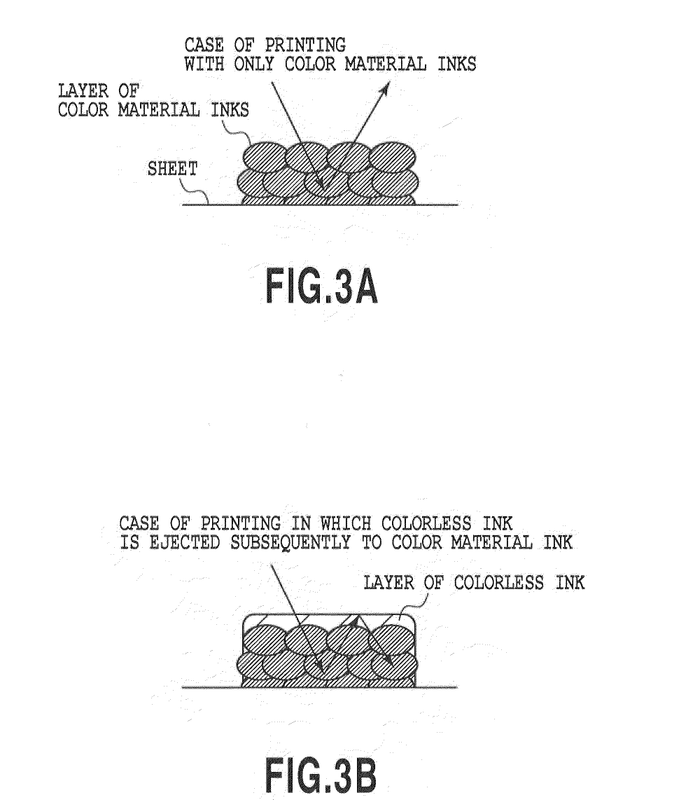

The colorless ink CO contains a polymer resin and is used for enhancing color reproducibility, as disclosed in Japanese Patent Laid-open No. 2011-218564. The colorless ink CO is particularly effective not in a mat print medium having a rough surface, in which a pigment color material or a polymer resin is immersed in a reception layer of the print medium, but in a gloss print medium having a fine surface, in which a pigment color material or a polymer is deposited on a reception layer. That is to say, a color material ink layer on a gloss print medium is covered with the colorless ink having a low glossiness, thus reducing a reflected light from a dark part of an image and reproducing a color having a lower lightness. The further reduction of the lightness of the dark part enlarges a color region of the dark part accordingly, thus enhancing the reproducibility. This effect is conspicuous in printing in which dots are first formed with the color material ink, before the dots are formed with the colorless ink (hereinafter also referred to as “post-application printing”). FIGS. 3A and 3B are diagrams explanatory of the effect. FIG. 3A shows no use of a colorless ink. In contrast, in the case of post-application printing with the colorless ink as shown in FIG. 3B, the color material ink and the colorless ink are hardly mixed with each other, and therefore, a color material ink layer on the gloss print medium can be more effectively covered with the colorless ink having a low glossiness.

Returning to FIG. 1, the print head 1 is detachably mounted on the carriage 5. The drive force of a carriage motor 11 is transmitted to the carriage 5 via a timing belt 17, thereby making a reciprocating motion of the carriage 5 in the directions indicated by the arrows A1 and A2 (i.e., a main scanning direction) along a guide shaft 3 and the guide rail 4. During the motion of the carriage, an encoder sensor 21 attached to the carriage 5 reads a linear scale 19 disposed in the motion direction of the carriage so that the position of the carriage is detected. Printing is carried out on the print medium during the reciprocating motion (forward scan and backward scan). At this time, the print medium S2 is held between a conveyance roller 16 and pinch rollers 15 upstream of the print head 1 whereas it is held between a sheet discharge roller and a pulley roller, neither shown, downstream of the print head 1 while being conveyed on a platen 2.

During this printing operation, when the carriage 5 performs printing by one scanning in the direction indicated by the arrow A1, a conveyance motor 13 drives the conveyance roller 16 and the sheet discharge roller via a linear wheel 20. And then, the print medium S2 is conveyed by predetermined amount in the direction indicated by the arrow B that is a sub-scanning direction. Thereafter, the carriage 5 is moved in the direction indicated by the arrow A2 while the print medium S2 is printed. There are provided a head cap 10 and a recovery unit 14 at a home position, as shown in FIG. 1, for intermittently recovering the print head 1, as required.

The above-described operation is repeated, and then, the print medium is discharged upon completion of printing one print medium.

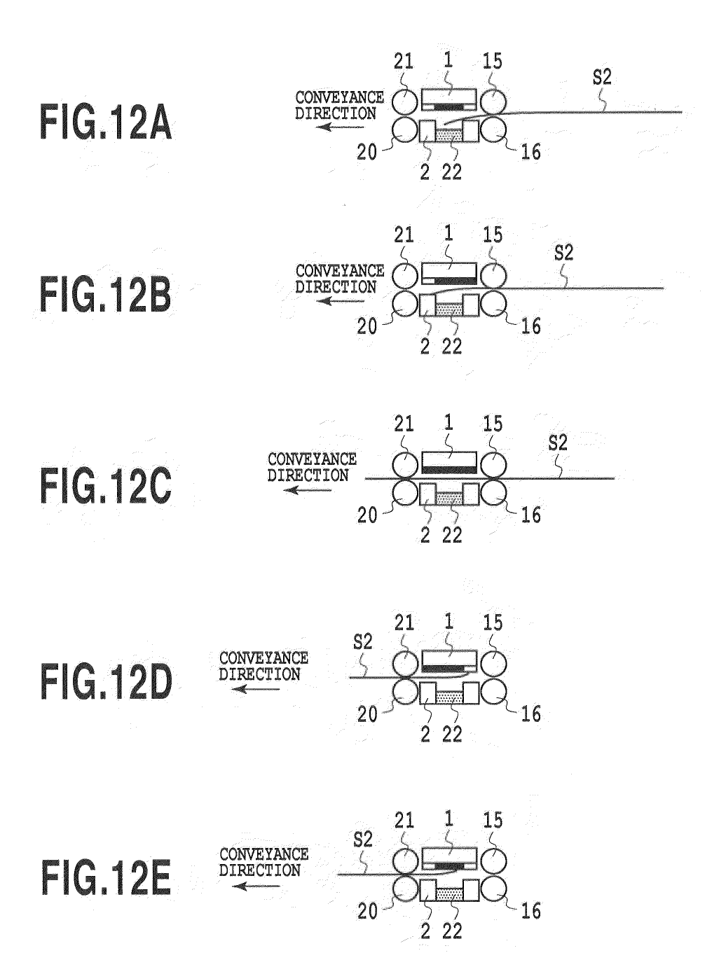

Here, explanation will be made on printing the front and rear ends of the print medium with reference to FIGS. 12A to 12E. FIGS. 12A to 12E are cross-sectional views schematically showing a printing part in the printing apparatus of the present embodiment. The print medium S2 is conveyed from upstream in the conveyance direction according to the rotation of the conveyance roller 16 in a state in which it is held between the conveyance roller 16 and the pinch roller 15, and then, the print medium S2 is fed to a position where its front end (i.e., a front region) faces the print head 1. The central portion of the platen 2 is hollowed, and then, a platen absorber 22 is put into the hollow.

As shown in FIG. 12A, in a case where the front end of the print medium S2 is printed, the use is restricted to only nozzles located at a position equivalent to the width of the platen absorber 22 (i.e., nozzles in a black section in FIG. 12A), thus performing printing. In the present embodiment, 256 nozzles at the center out of 1024 nozzles for each color in the print head 1 are used for printing. With this printing, ink running off the print medium during printing the front end can be absorbed by the platen absorber 22. The print medium is held at the upstream portion thereof between the conveyance roller 16 and the pinch roller 15 during the front end printing: in contrast, the downstream front end portion is not held. Moreover, the platen is hollowed, and then, the platen absorber 22 is put into the hollow. Consequently, an interval defined between the front end portion of the print medium S2 and the print head 1 is easily to be fluctuated. The behavior of the front end portion of the print medium S2 may be varied by factors such as the curling characteristics of the print medium S2, a temperature and humidity environment, and a time required for printing the front end, and therefore, the print medium S2 may move close to or apart from the print head 1.

Upon completion of printing the front end portion, the number of nozzles to be used in printing is gradually increased, as shown in FIG. 12B. The 1024 nozzles (i.e., nozzles in a black section in FIG. 12C) are used in printing in a case where the central portion of the print medium S2 is printed. After the front end portion of the print medium S2 reaches a nip portion where it is held between the sheet discharge roller 20 and the pulley roller 21, the print medium S2 is held at the upstream portion thereof between the conveyance roller 16 and the pinch roller 15 whereas it is held at the downstream portion thereof between the sheet discharge roller 20 and the pulley roller 21, as shown in FIG. 12C. Consequently, the print medium S2 is held both upstream and downstream, that is, at the two points, so that the interval between the print head 1 and the print medium S2 is constant within a predetermined range.

After the rear end of the print medium S2 goes through between the conveyance roller 16 and the pinch roller 15, an interval between the rear end portion (i.e., a rear region) of the print medium S2 and the print head 1 becomes unstable, as shown in FIG. 12D. The number of nozzles to be used in printing is gradually decreased, and then, printing is performed in a state in which the number of nozzles to be used is restricted to 256 nozzles (i.e., nozzles in a black section in FIG. 12E) at the time of image formation of the rear end portion of the print medium S2, as shown in FIG. 12E. At this time, ink running off the print medium during printing the rear end is absorbed by the platen absorber 22.

As described above, in printing the front or rear end portion of the print medium S2, the print medium is held either upstream or downstream, and therefore, the interval between the print head 1 and the print medium S2 is liable to be fluctuated in comparison with the case where the print medium S2 is held both upstream and downstream during printing the central portion of the print medium S2.

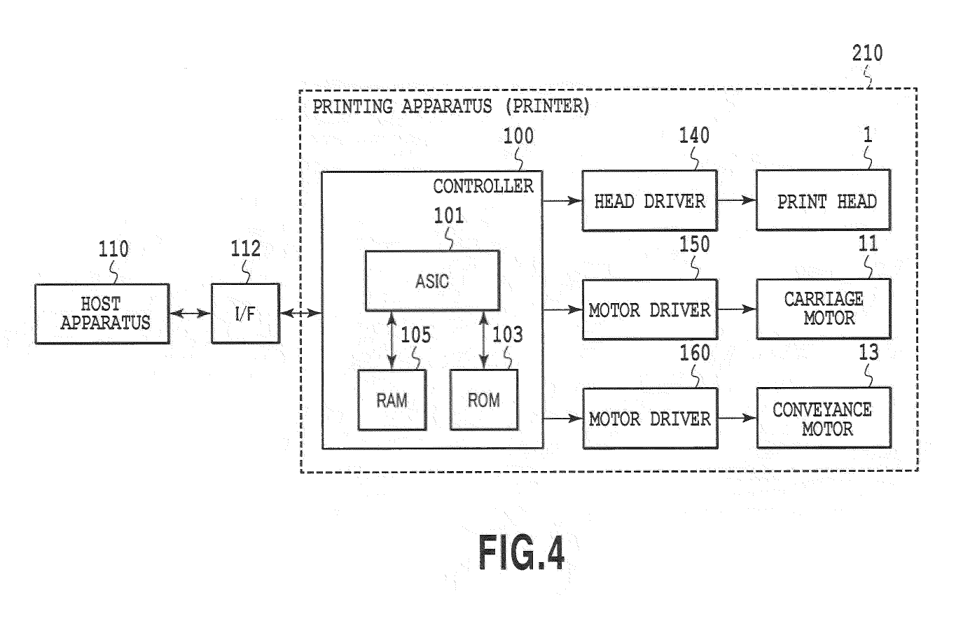

FIG. 4 is a block diagram illustrating a control structure in the ink jet printing apparatus in the present embodiment. A controller 100 is a main control part, and includes an ASIC 101 in, for example, a microcomputer mode, a ROM 103, and a RAM 105. The ROM 103 stores therein a dot arrangement pattern, a mask pattern, and other stationary data. An area, in which image data transmitted from a host apparatus 110 is developed, a work area, and the like are provided in the RAM 105. The ASIC 101 is adapted to read a program from the ROM 103 to control a printing operation with respect to the print medium based on the image data.

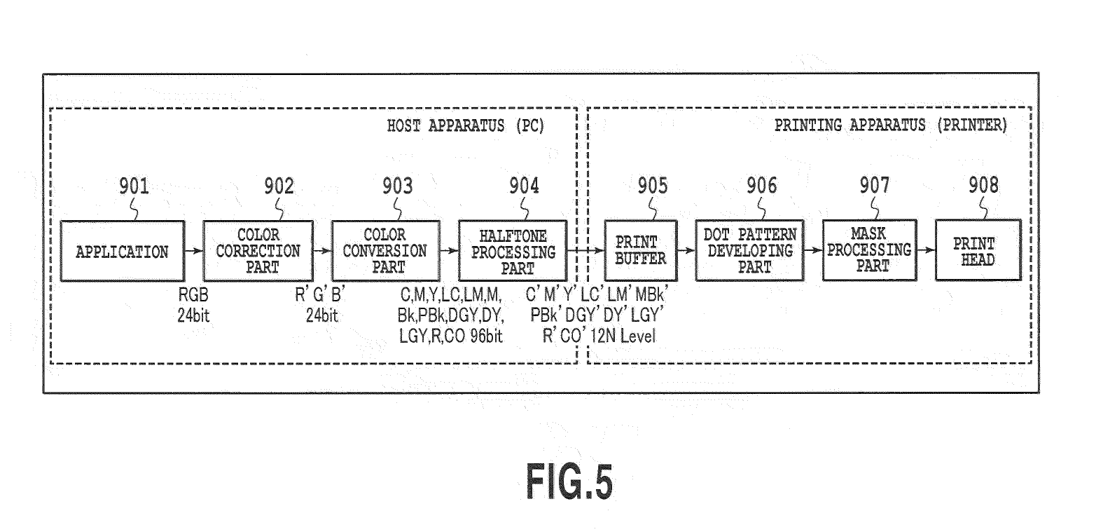

The host apparatus 110 is an image data supply source that may be a computer for creating and processing data on an image or the like concerned in printing or a reader part for reading the image. The host apparatus 110 performs image processing including color conversion processing according to the embodiment of the present invention, described later with reference to FIG. 5. The image data produced by the image processing, other commands, a status signal, and the like are transmitted to or received from the controller 100 in the printing apparatus via an interface (I/F) 112.

In the printing apparatus, a head driver 140 is adapted to drive the print head 1 based on the print data or the like. A motor driver 150 is designed to drive the carriage motor 11, and further, a motor driver 160 is adapted to drive the conveyance motor 13.

### (Image Processing)

Next, a description will be given of the image processing in the present embodiment.

FIG. 5 is a block diagram illustrating the structure of the image processing of the ink jet printing apparatus and the host apparatus according to the embodiment of the present invention. In FIG. 5, reference numeral 901 designates an application on a personal computer (PC) as the host apparatus. Image data consisting of 8 bits of each of RGB, that is, 24 bits in total is input into a color correction part 902 from the application 901. The color correction part 902 is adapted to convert the input RGB data into different R′G′B′ data, and to mainly convert data on a color area, which can be reproduced with the RGB data stored in the application 901, into data on a color area, which can be reproduced in the printing apparatus. This converting processing is generally performed by using a three-dimensional LUT (abbreviating a look-up table) and interpolation calculation. A plurality of kinds of contents of the LUT are prepared for the types of color correction, and therefore, they are appropriately chosen by a user and set by the application. For example, in a case where a photographic image is to be output, a photographic LUT is used; and in a case where a graphic image is to be output, a graphic LUT is used.

The R′G′B′ data consisting of 24 bits output from the color correction part 902 is input into a color conversion part 903 that converts the R′G′B′ data (i.e., a color signal) into ink color data (i.e., an ink color signal) to be used in the ink jet printing apparatus. In the present embodiment, the ink color data consists of twelve colors: namely, C, M, Y, LC, LM, MBk, PBk, DGy, Gy, LGy, R, and CO corresponding to the colors of the inks ejected by the head 1. An output signal from the color conversion part is output data consisting of 8 bits in each color, that is, 96 bits in twelve colors.

A halftone processing part 904 subjects an input multivalued signal in 8 bits equal to 256 values in each color to pseudo halftone processing (halftoning) with error diffusion, and consequently, converts the multivalued signal into data in N values less than 256 values. The N-value is, for example, about 3 to 16 expressed in 2 to 4 bits in each color. Although it is converted into three values in the present embodiment, the present invention is not limited to this. It is to be understood that it may be converted into binary.

The above-described processing parts are configured in the host apparatus: in contrast, processing parts, described below, are configured in the printing apparatus. Specifically, in the printing apparatus, a print buffer 905 stores therein the halftoned N-value ink color data transferred from the host apparatus (PC).

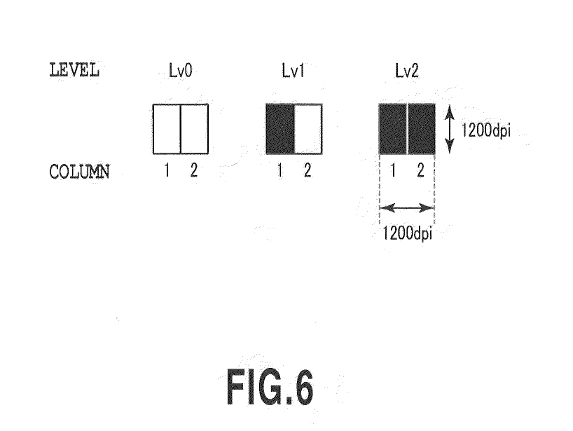

A dot pattern developing part 906 selects a dot arrangement pattern corresponding to a value indicated by the N-value data stored in the print buffer 905, and then, obtains dot data (binary data) on the selected arrangement pattern. FIG. 6 illustrates the dot arrangement pattern. As shown in FIG. 6, dot arrangement patterns are determined according to three values (levels) of 0 to 2 indicated by input 3-value data. Specifically, dot printing (“1”: a black pixel) and dot non-printing (“0”: a white pixel) are determined for each of the three levels with respect to two pixels in a lateral direction multiplied by one pixel in a vertical direction.

One pixel on the dot arrangement pattern has a resolution of 2400 dpi×1200 dpi in the present embodiment. Specifically, in the present embodiment, the image data transferred from the host apparatus has a resolution of 1200 dpi×1200 dpi, and then, the dot pattern developing part converts the resolution into 2400 dpi×1200 dpi. Incidentally, the size of a dot that is actually printed is about 30 μm in diameter. For example, two dots are printed in a partly overlapping manner on a dot arrangement pattern of the level 2.

A mask processing part 907 determines scanning a dot of each color whose printing is determined through dot arrangement patterning processing by the dot pattern developing part 906, followed by multi-pass printing with mask patterns in a mutually complementary relationship.

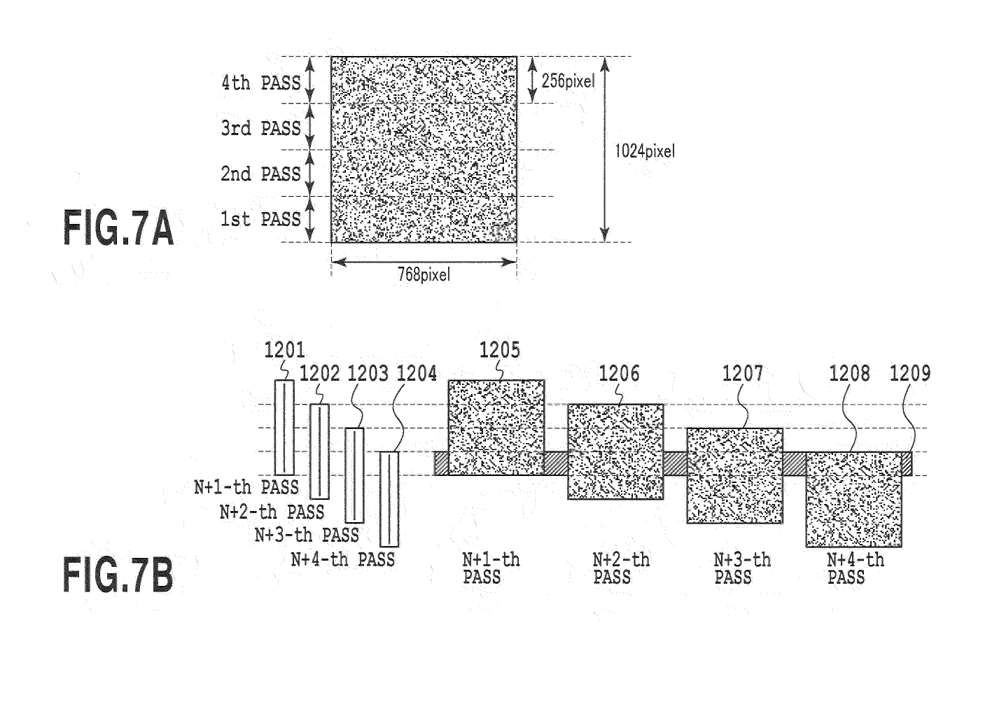

Here, explanation will be made on a general mask pattern and the general multi-pass printing with reference to FIGS. 7A and 7B. FIG. 7A is a diagram illustrating an example of a 4-pass mask pattern, with which an image is formed by scanning four times. This mask pattern expresses print permitting pixels (ON) in each pass by black dots whereas print non-permitting pixels (OFF) by white dots, wherein the arrangement of these dots is random. A pixel size is 1024 pixels×768 pixels in vertical and lateral directions, wherein the vertical direction indicates a nozzle array direction in the print head whereas the lateral direction indicates a main scanning direction in which the print head scans. Here, the pixel size in the vertical direction being 1024 is equal to the number of nozzles in the print head being 1024. As indicated by broken lines in FIG. 7A, mask areas obtained by quartering 1024 pixels in the vertical direction into 256 are referred to as mask patterns in first to fourth passes, respectively. These mask patterns stand in the complementary relationship. In the present embodiment, the mask patterns in the first to fourth passes have substantially the same print permitting ratio (hereinafter referred to as a duty), that is, a duty of about 25%. Here, the sum of the duties of the mask patterns in the complementary relationship corresponding to the passes is assumed to be 100%. FIG. 7B is a diagram schematically illustrating the multi-pass printing with the mask pattern illustrated in FIG. 7A. In FIG. 7B, reference numerals 1201 to 1204 denote print heads (that are for one color for the sake of simple explanation in FIG. 7B). FIG. 7B illustrates a state in which the print medium is sequentially conveyed at the time of the multi-pass printing of four passes, and then, the print heads are relatively shifted with respect to the same region of the print medium. The print data on the color material ink out of the print data produced in the mask processing part 907 is transmitted to a print head 908 that is driven based on the print data, to eject the ink according to the print data.

As described above, it is preferable to perform post-application printing in order to form a high-quality image having a high color reproducibility. In view of this, a plurality of print modes can be selected. In the case of the selection of a speed priority mode by a user, printing is performed in the above-described print mode in which only the color material ink is used: in contrast, in the case of the selection of an image quality priority mode, printing is performed in a post-application printing mode, described below. Explanation will be made below on mask patterns for the post-application printing and the multi-pass printing.

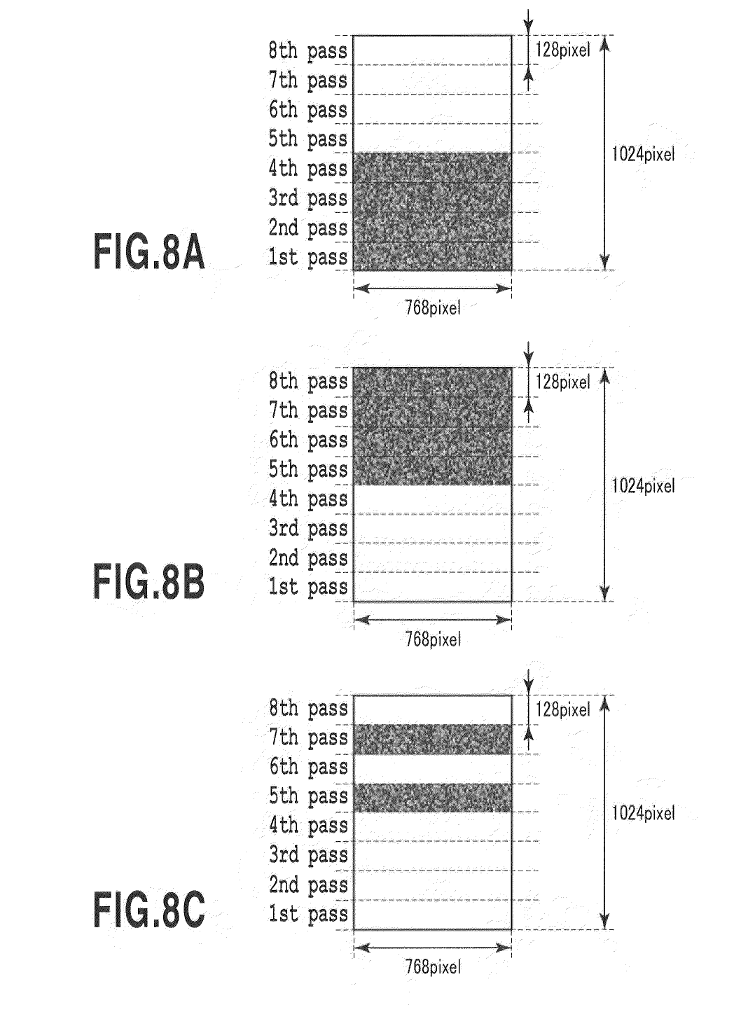

FIGS. 8A and 8B illustrate 8-pass mask patterns for the color material ink in the present embodiment and a comparative example, respectively. As shown in FIG. 8A, the mask pattern for the color material ink in the present embodiment has the ON dots only in the mask areas corresponding to the 1^{st} pass, the 2^{nd} pass, the 3^{rd} pass, and the 4^{st} pass and does not have any ON dots in the mask areas corresponding to the 5^{th} pass, the 6^{st} pass, the 7^{th} pass, and the 8^{th} pass. Specifically, the printing is performed with the color material ink in a region (i.e., a unit area) having a width corresponding to 128 pixels by scanning four times. The duty of each of the mask areas in the 1^{st} pass, the 2^{nd} pass, the 3^{rd} pass, and the 4^{th} pass is about 25%.

In contrast, FIG. 8C illustrates a mask pattern for the colorless ink in the present embodiment. As shown in FIG. 8C, the mask pattern for the colorless ink does not have any ON dots in portions corresponding to the 1^{st} pass to the 4^{th} pass whereas the mask pattern for the colorless ink has the ON dots in mask areas corresponding to the 5^{th} pass and the 7^{th} pass. Specifically, printing with the colorless ink is performed by scanning twice. Each of the duties in mask areas corresponding to the 5^{th} pass and the 7^{th} pass is about 50%. In the present embodiment, printing in a unit region is completed by eight scans consisting of alternately forward and backward scans. In this case, the printing with the colorless ink is performed in the 5^{th} pass and the 7^{th} pass, that is, by scanning in the same direction (a forward scan on the assumption that the 1^{st} pass is referred to as a forward scan). Consequently, the printing misregistration of the dots with the colorless ink can be reduced, and further, the fluctuation of a coverage with respect to the color material ink can be suppressed, as described later.

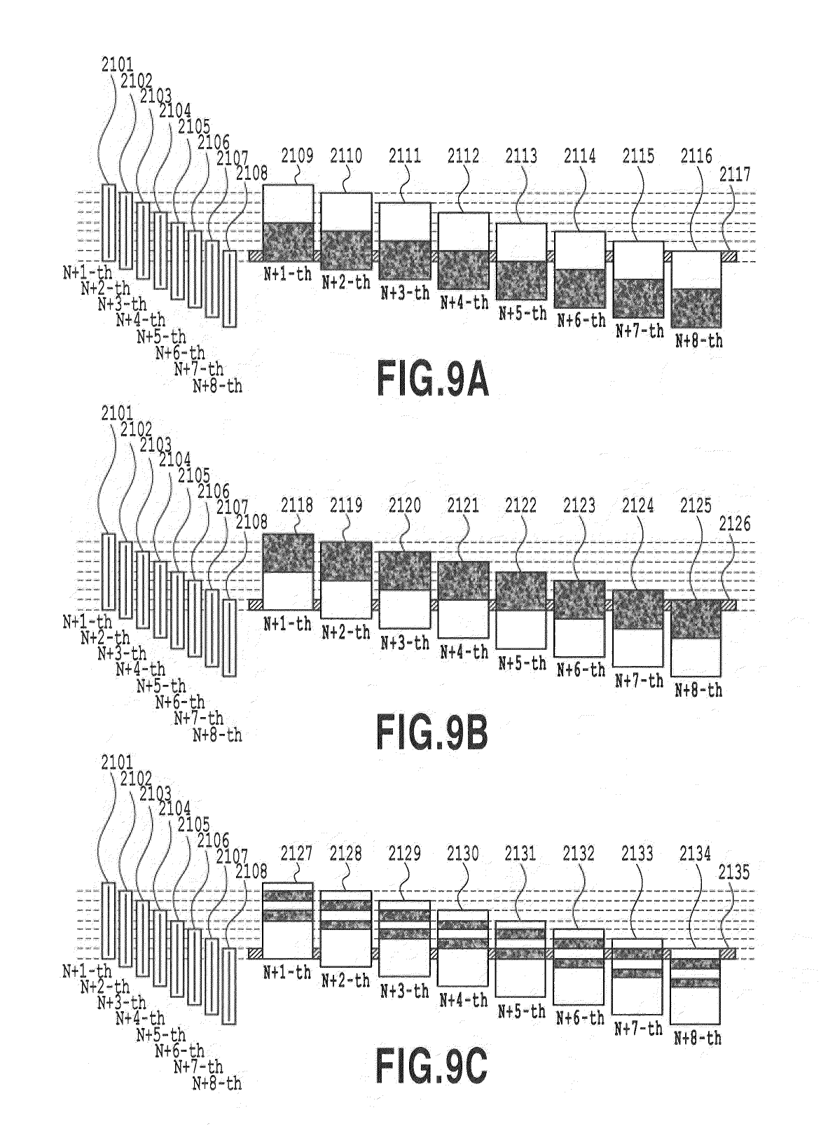

FIGS. 9A and 9C are diagrams explanatory of the multi-pass printing with the mask pattern for the color material ink and the mask pattern for the colorless ink in the present embodiment illustrated in FIGS. 8A and 8C, respectively. Moreover, FIG. 9B is a diagram explanatory of the multi-pass printing with the mask pattern for the color material ink in the comparative example. In FIGS. 9A and 9C, reference numerals 2101 to 2108 designate the print heads (that are explained by way of print heads for one color for the sake of simplification in FIGS. 9A and 9C). FIGS. 9A and 9C illustrate a state in which the print medium is sequentially conveyed at the time of the multi-pass printing of 8passes, and then, the print heads are relatively shifted with respect to the same area (i.e., a unit area) of the print medium. FIG. 9A illustrates the multi-pass printing with the mask pattern for the color material ink illustrated in FIG. 8A: in contrast, FIG. 9C illustrates the multi-pass printing with the mask pattern for the colorless ink illustrated in FIG. 8C. The printing with the color material ink illustrated in FIG. 9A is performed in 4 passes of the first half, that is, in the 1st pass to the 4^{th} pass. At this time, the print head performs printing by the main scanning such that, assuming that N+1-th scanning as the 1^{st} pass is performed in the forward direction, N+2-th scanning as the 2^{nd} pass is performed in the backward direction; N+3-th scanning as the 3^{rd} pass is performed in the forward direction; and N+4-th scanning as the 4^{th} pass is performed in the backward direction. Since an image is formed with the mask patterns having a duty of 25% by the N+1-th scanning to the N+4-th scanning, almost half of dots are formed on the print medium with the color material ink by the forward scan whereas almost the remaining half of dots are formed by the backward scan. In contrast, the multi-pass printing with the colorless ink illustrated in FIG. 9C is performed by scanning two times in the second half, that is, in the 5^{th} pass and the 7^{th} pass. In this case, the printing with the color material ink is performed, and then, the printing with the colorless ink is performed (the post-application printing).

At this time, in the main scanning by the print head, printing is performed by the N+5-th forward scanning as the 5^{th} pass, and further, printing is performed by the N+7-th forward scanning as the 7^{th} pass in the same manner. Consequently, dots are formed with the color material ink by both of the forward and backward scans in mixture whereas all dots are formed with the colorless ink only in the forward scan. Specifically, an image is formed with the color material ink during the backward scan whereas an image is formed with both of the color material ink and the colorless ink during the forward scan at the same time. Thus, in spite of a special print control in which the printing by scanning in the forward and backward directions and the printing by scanning in either direction are performed in mixture, no useless scanning can occur.

In contrast, in a case where the multi-pass printing with the colorless ink is performed in a manner illustrated in FIG. 9B with the mask pattern in the comparative example illustrated in FIG. 8B, printing is performed in the second half of the 5^{th} pass to the 8^{th} pass. Also in this case, printing is performed with the color material ink, and then, printing is performed with the colorless ink. In the comparative example, dots are formed with the colorless ink by forward and backward scans in mixture.

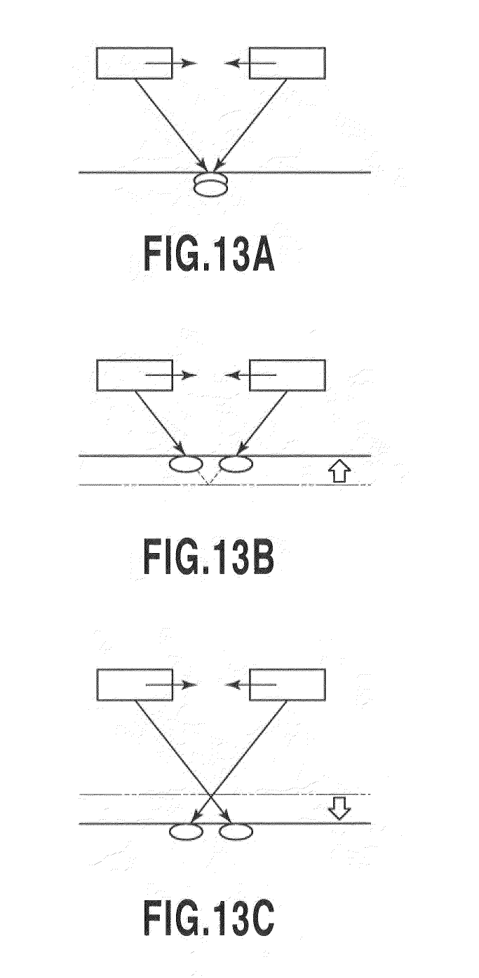

As described above, the interval between the print head 1 and the print medium S2 is liable to be fluctuated during printing the front and rear end portions of the print medium S2, and therefore, landing position variation possibly occurs. FIGS. 13A to 13C are views schematically showing the relationship between an ink droplet ejected in a case where the print head 1 scans in the forward direction and the landing position of the ink droplet ejected during scanning in the backward direction. As shown in FIG. 13A, in a case where the interval between the print head 1 and the print medium S2 is not fluctuated, an ink droplet ejected during scanning by the print head leftward, that is, in the forward direction in FIG. 13A and an ink droplet ejected during scanning rightward, that is, in the backward direction are superimposed on a sheet. In contrast, as shown in FIG. 13B, in a case where the interval between the print head 1 and the print medium S2 is shortened, an ink droplet ejected during scanning in the backward direction is landed at a position shifted leftward from an ink droplet ejected during scanning in the forward direction. Moreover, as shown in FIG. 13C, in a case where the interval between the print head 1 and the print medium S2 is lengthened, an ink droplet ejected during scanning in the backward direction is landed at a position shifted rightward from an ink droplet ejected during scanning in the forward direction. In this manner, in a case where the interval between the print head 1 and the print medium S2 is fluctuated, the positions of the dots formed during bidirectional printing may be shifted during printing the front and rear end portions of the print medium S2.

In contrast, since the colorless ink is applied onto the print medium by scanning only in either direction (i.e., the forward scan), it is possible to prevent the positions of the dots formed by the forward and backward scans from being shifted in the present embodiment even if the interval between the print head 1 and the print medium S2 is fluctuated, as described above.

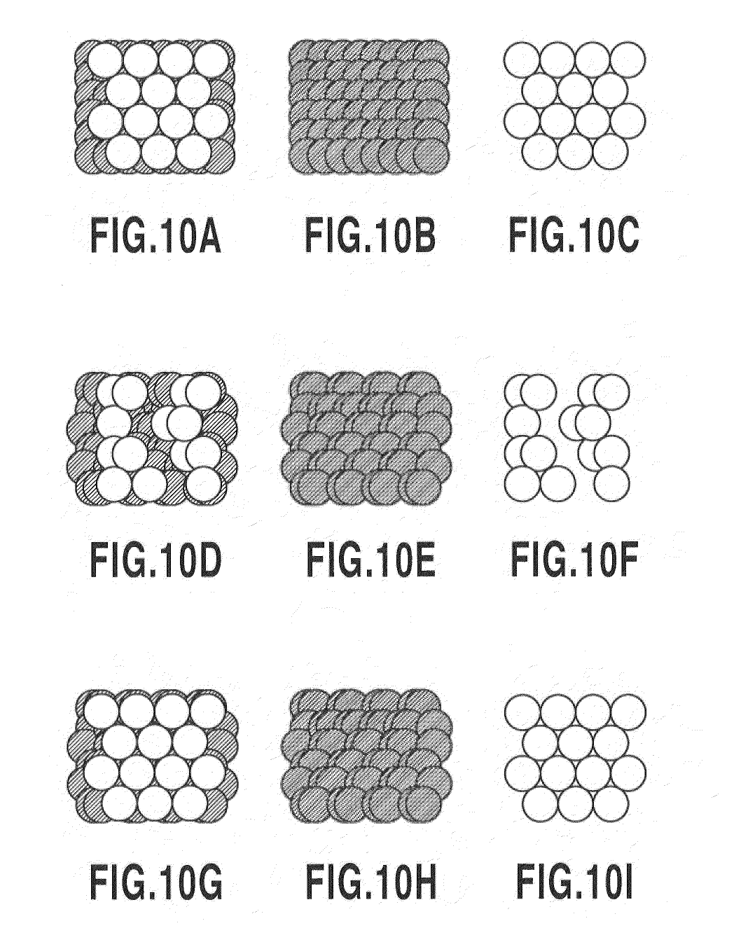

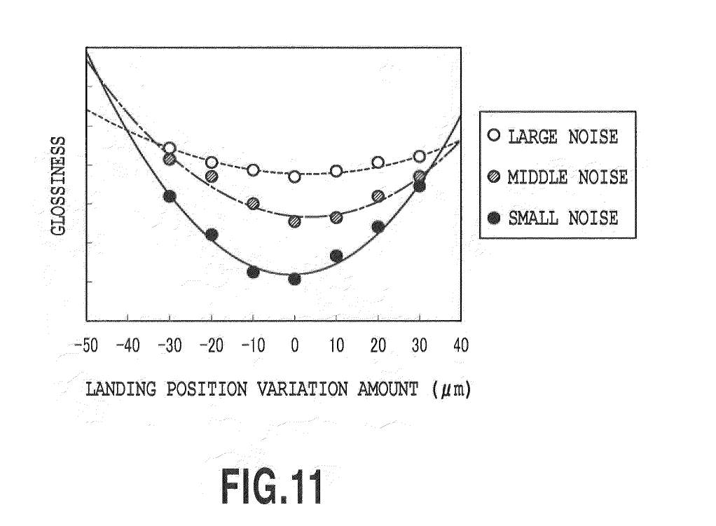

FIGS. 10A to 10I are diagrams explanatory of changes in coverage of, in particular, the colorless ink in a case where printing is performed in both of forward and backward scans directions with the color material ink and the colorless ink. FIGS. 10A to 10I illustrate dot arrangement in dark gradation in which an image drawback caused by the landing position variation is easily visible by way of examples in which the number of dots formed with the color material ink is greater.

FIGS. 10A to 10C illustrate a case of ideal dot landing positions (i.e., dot formation positions) without any fluctuation in interval between the print head 1 and the print medium S2. In FIGS. 10A to 10C, shaded dots indicate dots formed with the color material ink whereas white dots indicate dots formed with the colorless ink. The surface coverage of the colorless ink on the print medium is about 90% that is lower than that of the color material ink. In the present embodiment, the total amount of color material ink for use in an area equivalent to one pixel of 600 dpi is about 25 pl that is most in expressing the dark gradation: in contrast, the total amount of colorless ink is about 5 pl. In this manner, the amount of each of color material ink and colorless ink to be used is optimized, thus effectively enhancing the reproducibility in the dark gradation.

FIGS. 10G to 10I illustrate the relationship of the landing positions when printing the front and rear end portions of the print medium S2 in the present embodiment. The dots are formed with the color material ink by forward and backward scans. Therefore, when the interval between the print head and the print medium is fluctuated, the landing positions are shifted, as shown in FIG. 10H. In this case, since the number of dots formed with the color material ink is great in the example shown in FIG. 10H, a cover area of a sheet is not so changed from that in the case of the ideal landing position shown in FIG. 10B even if the landing positions are shifted. In contrast, the dots are formed with the colorless ink by either the forward scan or the backward scan, as shown in FIG. 10I, and therefore, even if the interval between the print head and the print medium is fluctuated, the landing position variation caused by the forward scan and the backward scan can be suppressed, so that the cover area of the sheet (i.e., a coverage) can be made substantially the same as that at the ideal landing position shown in FIG. 10C.

In contrast, since dots are formed with colorless ink by forward and backward scans in the comparative example shown in FIGS. 10D to 10F, a cover area of a sheet having the dots formed with the colorless ink shown in FIG. 10F is largely fluctuated with respect to the ideal landing position shown in FIG. 10C. In this manner, the cover area of the dots with the colorless ink shown in FIG. 10D is largely shifted from the ideal landing position shown in FIG. 10A by the adverse influence of the fluctuation in interval between the print head 1 and the print medium S2 at the front and rear ends of the print medium in the comparative example. In contrast, the printing can be achieved with little influence on the coverage in the present embodiment, as shown in FIG. 10G. Consequently, gloss unevenness that is visually recognized at the front and rear ends of the print medium in the comparative example can be reduced by the printing in the present embodiment.

As described above, in order to cope with the gloss unevenness caused by the fluctuation at the front and rear end portions of the print medium S2, the printing is performed at the front and rear end portions of the print medium with the colorless ink in either direction. Although image formation may be conceived by bidirectional scanning in other areas, both of the front and rear ends and the other areas are printed with the colorless ink in unidirectional scanning in the present embodiment. This is because the uniformity of an image in an area, in which the unidirectional printing and the bidirectional printing are switched, may be possibly reduced. Assuming that the registration between the dots formed by the forward scan in the bidirectional printing area and the dots formed by the backward scan is even slightly shifted from the ideal state by way of one example, there is not at all the bidirectional landing position variation in the area in which the dots are formed in either direction. In contrast, the landing position variation occurs in the area in which the dots are formed in both of the directions, thereby possibly inducing a difference in gloss.

The present invention is not limited to a mode in which the present invention is applied to the printing with the colorless ink in printing the front or rear end of the print medium. For example, it is to be understood that the present invention should be applied irrespective of the print position on the print medium.

### Second Embodiment

A second embodiment of the present invention relates to a mode in which one nozzle array for a colorless ink is arranged in a print head. Specifically, in a case where ink is ejected by two or more nozzle arrays to thus form dots, there is a possibility of landing position variation between dots formed by nozzles due to various factors. In the present embodiment, such landing position variation is prevented by arranging one nozzle array for a colorless ink. The explanation of the same configuration as that in the above-described first embodiment will be omitted below.

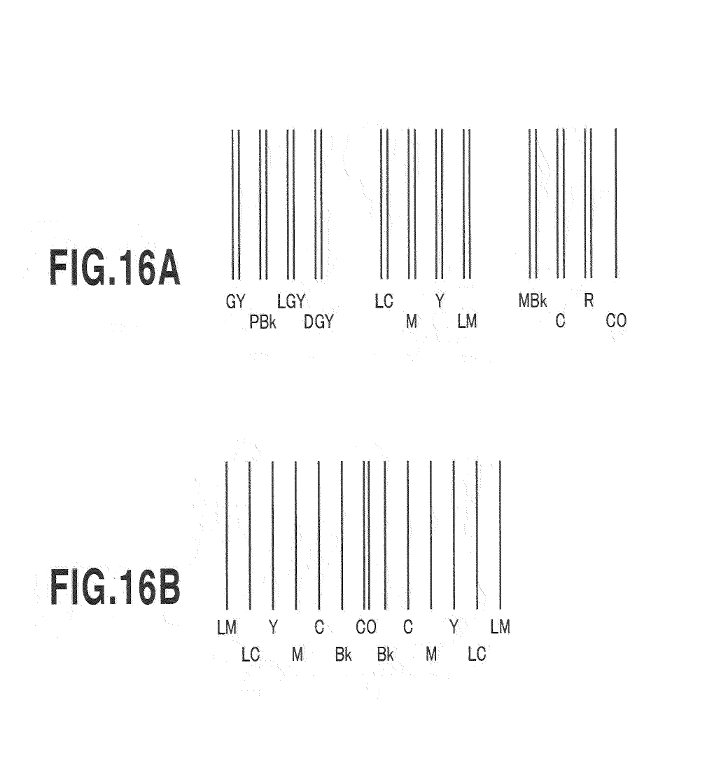

FIG. 16A is a diagram illustrating the arrangement of nozzle arrays in a print head according to the present embodiment. As illustrated in FIG. 16A, two nozzle arrays having nozzles are arrayed at an interval of 600 dpi as for color material inks in the present embodiment, like the nozzle array configuration in the first embodiment. In contrast, only one nozzle array having nozzles for a colorless ink CO is arrayed at an interval of 600 dpi. Ejection amount of colorless ink is 6 pl that is twice 3 pl of each of the color material inks.

In this manner, the number of nozzle arrays is reduced, so that the factors for the landing position variation of the colorless ink that is liable to degrade the quality of an image are reduced, thus making it possible to reduce the gloss unevenness caused by the fluctuation in coverage.

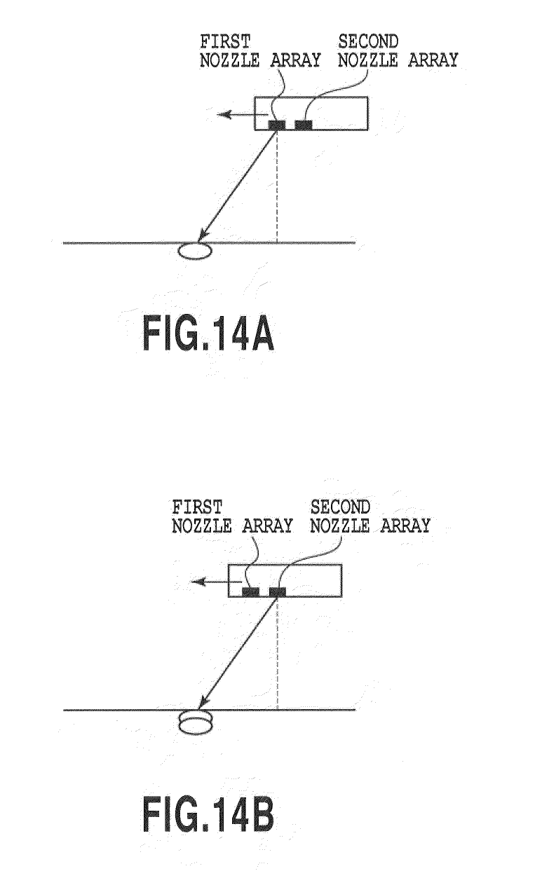

FIGS. 14A and 14B are views schematically showing a landing position in a case where the ink is ideally landed by two nozzle arrays. More particularly, by scanning in one direction, ink is ejected from a first nozzle array, as shown in FIG. 14A, and sequentially, the ink is ejected from a second nozzle array, as shown in FIG. 14B. In this ideal state, ink droplets are ejected from the two nozzle arrays at the same ejection angle. The ink droplet is ejected from the second nozzle array at a position indicated by a broken line at which the ink droplet is ejected from the first nozzle array in the scanning direction, so that a dot can be formed at the same position. In this manner, in the case of the ideal landing of the ink droplet, no misalignment occurs between a dot with the ink droplet ejected from the first nozzle array and a dot with the ink droplet ejected from the second nozzle array, and consequently, printing can be achieved in the ideal dot arrangement.

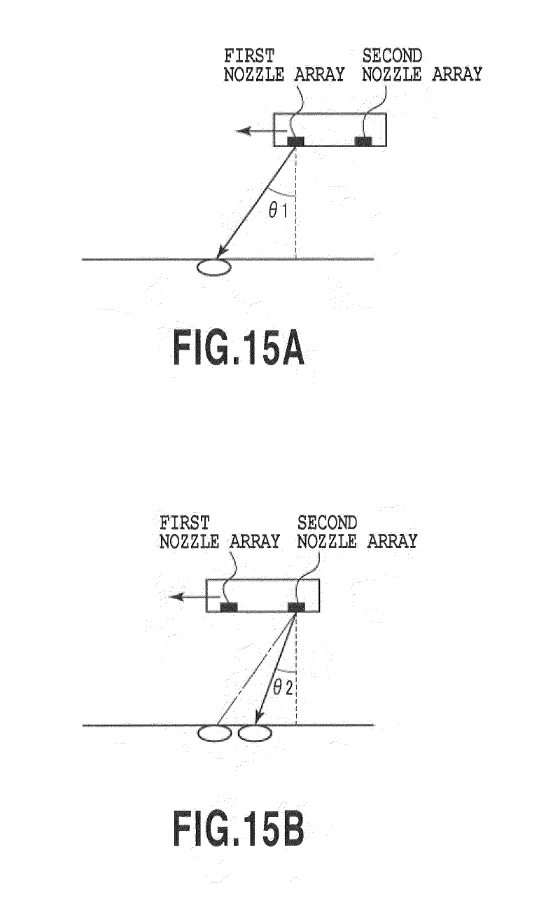

In contrast, FIGS. 15A and 15B are views schematically showing a landing position in a case where an ink droplet is ejected at different angles from each of two nozzle arrays. As shown in FIG. 15A, ink is ejected from a first nozzle array at an angle of θ1 with respect to the direction of a sheet, and sequentially, the ink is ejected from a second nozzle array at an angle of θ2, as shown in FIG. 15B. In this manner, in a case where the ink cannot help being ejected from the nozzle arrays at different ejection angles, a dot formed with an ink droplet ejected from the first nozzle array and a dot formed with an ink droplet ejected from a second nozzle array are landed with a shift. In addition, as described above in the first embodiment, in a case where the interval between the print head 1 and the print medium S2 is changed, position gap on the sheet is changed between the dot formed by the first nozzle array and the dot formed by the second nozzle array.

Incidentally, the difference in ejection angle between the nozzle arrays, as described above, is caused by variations produced in fabricating nozzles for a print head. Specifically, the causes are exemplified by the smoothness of a nozzle formation surface, a nozzle formation angle, a fine misalignment between the nozzle formation position of each of nozzles and the position of an ejection energy transducing element for an ink droplet such as a heater or a piezoelectric element. The landing position variation between the nozzle arrays may be corrected by detecting misregistration, and then, shifting an ejection timing in anticipation of the misregistration. In the example of the second nozzle array shown in FIG. 15B, the ejection timing is shifted such that the second nozzle array ejects ink at a position, at which scanning further proceeds, beyond a position indicated by a broken line, at which the first nozzle array ejects the ink, thus suppressing the adverse influence of the difference in ejection angle between the nozzle arrays. However, it is difficult to predict and detect how the interval between the print head and the print medium, produced at the front and rear end portions of the print medium, is fluctuated, thereby making it difficult to cope with the fluctuation by adjusting the ejection timing at the front and rear ends. In contrast, according to the present embodiment, the number of nozzle arrays for the colorless ink, in which the landing position variation conspicuously appears as an image drawback, is made less than that for the color material inks, thus reducing the factors for the landing position variation between the nozzle arrays, to thus reduce the gloss unevenness caused by the fluctuation in coverage.

Incidentally, although the use of the mask pattern by either forward scan or backward scan achieves effective printing with the colorless ink in the present embodiment, as shown in FIG. 9C, it may be combined with the use of the mask pattern for forming an image in both directions, as shown in FIG. 9B.

### Third Embodiment

A third embodiment according to the present invention relates to a mode in which two nozzle arrays for a colorless ink are arranged at the center to thus reduce landing position variation even if the landing position variation occurs in a configuration for symmetrically arranging nozzle arrays for color material inks to suppress color unevenness caused by forward and backward scans. The explanation on the same constituent elements in the present embodiment as those in the first embodiment will be omitted.

FIG. 16B is a diagram illustrating the arrangement of nozzle arrays in a print head in the present embodiment. In the present embodiment, the number of colors is seven, that is, C, M, Y, Bk, LC, LM, and CO. Two nozzle arrays, each having nozzles arrayed at an interval of 600 dpi, are arranged for each of the colors. The nozzle arrays for each of the colors are arranged symmetrically in a lateral direction, and therefore, the interval between the two nozzle arrays for each of the colors is different. With this symmetric arrangement, the order of colors landed on a sheet in the forward and backward scans becomes the same, thus reducing the color unevenness.

Moreover, in the present embodiment, the two nozzle arrays for the colorless ink are arranged at the center, so that the distance between the arrays can be made smaller than those between the arrays for the other color material inks. In general, variations in fabricating nozzles tend to become larger as the distance between the nozzles becomes larger. The landing position variation between the nozzle arrays for the colorless ink, as explained with reference to FIG. 15B, hardly occurs more than that for the other color material inks. In this manner, the interval between the nozzle arrays for the colorless ink (i.e., the distance between nozzles) in which the landing position variation conspicuously appears as the image drawback is made to become smaller than the interval between the nozzle arrays for the other color material inks. Consequently, the factors that cause the landing position variation between the nozzle arrays can be reduced in comparison with the other ink colors. Hence, it is possible to suppress the gloss unevenness that is liable to be visible at the front and rear ends of the print medium due to the fluctuation of the coverage.

Incidentally, although the printing with the colorless ink in the present embodiment is effectively performed by using the mask pattern by either forward scan or backward scan, as shown in FIG. 9C, the above mask pattern may be combined with the mask pattern for forming an image in both of the directions, as shown in FIG. 9B.

In the above-described first to third embodiments, the description has been given of the mode in which the printing with the colorless ink is started in next scanning after the scanning in which the printing with the color material inks is finished by the use of the mask configuration shown in FIG. 9. However, the present invention is not limited to this. Scanning with the colorless ink may be started with a delay of at least one scanning after scanning for starting printing with the color material inks.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-130992 filed Jun. 21, 2013, which is hereby incorporated by reference herein in its entirety.

What is claimed is:

1. An ink jet printing apparatus, comprising:
a print head including arrays of nozzles for ejecting a color material ink containing a color material and nozzles for ejecting a colorless ink not containing a color material; and
a print control unit configured to cause a print head to scan a print medium for ejecting a color material ink onto the print medium and then ejecting a colorless ink to form dots with the colorless ink in such a manner as to cover dots formed with the color material ink,
wherein the ink jet printing apparatus is configured such that a shift of a dot formation position of the colorless ink is smaller than that of a dot formation position of the color material ink, the shift being caused by the scanning by the print head.

2. The ink jet printing apparatus as claimed in claim 1, wherein the print control unit causes the print head to eject the colorless ink in either of a forward scan and a backward scan of the print head whereas to eject the color material ink in both of the forward scan and the backward scan, so that the shift of the dot formation position of the colorless ink becomes smaller than that of the dot formation position of the color material ink, the shift being caused by the scanning by the print head.

3. The ink jet printing apparatus as claimed in claim 2, wherein the print control unit performs conveying of the print medium with respect to the print head, to perform printing, and at least a front region and a rear region of the print medium, which are defined by the conveyance, is printed in either of the forward scan and the backward scan of the print head.

4. The ink jet printing apparatus as claimed in claim 1, wherein the number of nozzles for the colorless ink is smaller than that of nozzles for the color material ink.

5. The ink jet printing apparatus as claimed in claim 1, wherein a plurality of nozzles for each of the colorless ink and the color material ink are arrayed in a scanning direction, a distance between the nozzles for the colorless ink being smaller than that between the nozzles for the color material ink.

6. The ink jet printing apparatus as claimed in claim 1, wherein the colorless ink contains a polymer resin.

7. The ink jet printing apparatus as claimed in claim 1, wherein the color material ink contains a pigment color material.

8. An ink jet printing method for causing a print head to scan a print medium and then performs printing, the print head having arrays of nozzles for ejecting a color material ink containing a color material and nozzles for ejecting a colorless ink not containing a color material, the method comprising:
a print controlling step of causing a print head to scan a print medium for ejecting a color material ink onto the print medium and then ejecting a colorless ink to form dots with the colorless ink in such a manner as to cover dots formed with the color material ink,
wherein a shift of a dot formation position of the colorless ink is smaller than that of a dot formation position of the color material ink, the shift being caused by the scanning by the print head.

9. A printing apparatus comprising:
a print head for ejecting color ink and clear ink for coating the color ink to a print medium;
first and second rollers that are provided on an upstream side and a downstream side of printing position on the print medium by the print head in a conveying direction of the print medium, respectively, so as to support and convey the print medium; and
a print control unit configured to cause the print head and the print medium to move forward and backward relatively to each other in directions crossing the conveying direction and cause the print head to eject the color ink and the clear ink in a plurality of the relative movements of the print head and the print medium for performing printing to a unit area on the print medium,
wherein the print control unit causes the print head to eject the clear ink in only the plurality of the relative movement of either of the forward and backward movements, at least in a case where the print medium is supported only by either one of the first and the second rollers.

10. The printing apparatus as claimed in claim 9, wherein the print control unit causes the print head to eject the clear ink in only the plurality of the relative movement of either of the forward and backward movements, also in a case where the print medium is supported by both of the first and the second rollers.

11. The printing apparatus as claimed in claim 9, wherein the print control unit causes the print head to eject the clear ink in only the plurality of the relative movement of either of the forward and backward movements, in a case where the print medium is supported by only the first roller of the first and the second rollers and in a case where the print medium is supported by only the second roller of the first and the second rollers.

12. The printing apparatus as claimed in claim 9, wherein the print control unit causes the print head to eject the color ink in the plurality of the relative movement of both of the forward and backward movements, at least in a case where the print medium is supported only by either one of the first and the second rollers.

13. The printing apparatus as claimed in claim 9, wherein the print control unit controls ejection of each of the color ink and the clear ink using mask patterns which define print permitting pixels in each of the plurality of the relative movement.

14. A printing apparatus comprising:
a print head for ejecting color ink and clear ink for coating the color ink to a print medium;
a conveying unit configured to convey the print medium in a conveying direction; and
a print control unit configured to cause the print head and the print medium to move forward and backward relatively to each other in directions crossing the conveying direction and cause the print head to eject the color ink and the clear ink in a plurality of the relative movements of the print head and the print medium for performing printing to a unit area on the print medium,
wherein the print control unit causes the print head to eject the clear ink in only the plurality of the relative movement of either of the forward and backward movements, at least in a case where printing is performed to either one of end portions of the print medium in the conveying direction.

15. The printing apparatus as claimed in claim 14, wherein the print control unit causes the print head to eject the clear ink in only the plurality of the relative movement of either of the forward and backward movements, also in a case where printing is performed to a central portion of the print medium in the conveying direction.

16. The printing apparatus as claimed in claim 14, wherein the print control unit causes the print head to eject the clear ink in only the plurality of the relative movement of either of the forward and backward movements, in a case where printing is performed to an upstream end portion of the print medium in the conveying direction and in a case where printing is performed to a downstream end portion of the print medium in the conveying direction.

17. The printing apparatus as claimed in claim 14, wherein the print control unit causes the print head to eject the color ink in the plurality of the relative movement of both of the forward and backward movements, at least in a case where printing is performed to either one of end portions of the print medium in the conveying direction.

18. The printing apparatus as claimed in claim 14, wherein the print control unit controls ejection of each of the color ink and the clear ink using mask patterns which define print permitting pixels in each of the plurality of the relative movement.
